(19) United States
(12) Patent Application Publication
(10) Pub. No.: US 2011/0049171 A1
(43) Pub. Date: Mar. 3, 2011

(54) Cup Lid

(76) Inventor: Daniel R. Morgan, Olathe, KS (US)

(21) Appl. No.: 12/851,305

(22) Filed: Aug. 5, 2010

Related U.S. Application Data
(60) Provisional application No. 61/237,152, filed on Aug. 26, 2009.

(51) Int. Cl. A47G 19/22; B31B 1/14

(52) U.S. Cl. 220/712; 493/340

(57) ABSTRACT

Disclosed is a cup lid like which would be snapped on to enclose a conventional soda, coffee, or other kind of conventional cup. The lid has one or more rupturable lines formed in it. The lines, when ruptured, create one or more hinged flaps. The flaps enable the lid to be substantially opened up so that solid items can be inserted into the cup and contained. This enables the cup, after primary use, to be used as a trash receptacle.

### RELATED APPLICATIONS

This invention application claims the benefit of U.S. Provisional Patent Application Ser. No. 61/237,152 filed Aug. 26, 2009, the entire contents of which are incorporated herein by reference.

### BACKGROUND OF THE INVENTION

1. Field of the Invention

This invention relates generally to lids and more specifically to hot and cold drink cup lids.

2. Description of the Related Art

Cup lids come in many different configurations. Some versions have small tear-out flaps enabling the rupturing of a portion of the lid. In some instances, the ruptured area is used to create an opening for drinking. In other cases, flaps are created to allow for the receipt of a straw.

Since conventional lids are designed to be ruptured prior to drinking, the affected section of the lid is minimized to avoid collateral spillage or leaking.

Normally, with these and other prior art devices, once the liquid product in the cup has been consumed, the cup and lid—now useless—are pitched into a trash receptacle as a low-density-waste item.

### SUMMARY OF THE INVENTION

Disclosed is a lid for a cup which allows trash or other objects to be inserted into and contained. Typical cups will have a liquid receiving area and some will have an upper rim and a mouth. The lid disclosed herein, in embodiments, has an outer peripheral portion that is received onto the upper rim of said cup so that it can be secured. Inside the rim, a liquid barrier portion contains liquid from splashing out of said cup when the lid is secured. In embodiments, a first line of weakness is formed in the lid enabling the containment portion to be ruptured to enable the passage of an object into the cup. The first line of weakness, in embodiments, has a length which is greater than a radius of the mouth of the cup or the radius of the lid, the first line of weakness being one of linear and curved.

In embodiments, the lid includes a second line of weakness, and the first and second lines of weakness crossing at or near a middle of the lid and when ruptured, the first and second lines creating four flaps, the flaps being inwardly flexible to allow for the passage of an object into the cup. The flaps, after the passage of the object, aid in retaining the object in the cup.

In other embodiments, two, three, four, or more lines of weakness can be formed to create a plurality of flaps.

In other embodiments, a first line of weakness is curved, and in some embodiments, C-shaped inside the periphery of the lid. In some embodiments the C-shape is defined in a plateua portion in a lid. Other variations have a knockout portion to releive the resistance to penetration.

In embodiments, the cup lid is substantially circular and has an outer portion adapted to snap on to a soda, or other conventional cup. The lid has an inner portion which includes at least one rupturable line. The line, when ruptured, creates a hinged flap. The flap enables the lid to be substantially opened up for the passage of solid items though the lid for containment. This, in embodiments, enables the cup, after primary use, to be used as a trash receptacle.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 is a perspective view showing a first disclosed embodiment for a cup lid;

FIG. 2A is a top view of the first disclosed embodiment;

FIG. 2B shows a top view of an alternative score pattern usable with a different type of lid than shown in FIG. 1;

FIG. 2C show a top view of yet another alternative score pattern useable with the same type of lid shown in the FIG. 1 embodiment;

FIG. 3 is a side cross-sectional view of the first disclosed embodiment shown in FIGS. 1 and 2A;

FIG. 4 is a perspective view showing a second disclosed embodiment for a cup lid;

FIG. 5A is a top view of the second disclosed embodiment shown in FIG. 4;

FIG. 5B shows a top view of an alternative score pattern usable with the same type of lid shown in FIG. 4;

FIG. 5C shows a top view of yet another alternative score pattern useable with the same type of lid shown in the FIG. 4 embodiment; and

FIG. 6 is a side cross-sectional view of the embodiment shown in FIGS. 4 and 5A.

### DETAILED DESCRIPTION

The present disclosed subject matter improves contemporary cup and lid systems by providing predetermined rupturable lines of weakness on the cup lid. These lines do not jeopardize the liquid containment aspects of the lid. Once the liquid product in the cup has been consumed, the rupturable lines allow for the insertion of trash into the cup without lid removal. Trying to insert trash into a cup the conventional way—by removing the lid—can be messy, and is difficult to execute while engaging in another task simultaneously (e.g., driving). But with the lids disclosed herein, the trash can be pushed into the cup as it exists, and it will be securely held after it is passed through the lid, since the lid performs a containment function. And in addition to containment, the lid enables the items of trash to be compacted, thereby, in general, allowing a greater number of trash items to be stored in the cup than could be stored without compacting.

In some embodiments, the rupturability is provided by creating lines of weakness in the lid. These lines can be created by scoring, perforation, injection molding, stamping, chemical treatment, laser ablation, ultrasonic administrations, die casting, or other methods.

Once the predetermined tear holes or lines have been broken, trash or other objects can be pushed through the scored weakened region. The lid does not need to be removed from the cup. Once a trash item has been received into the cup, the ruptured sections retract back to an extent, performing a containment function.

In some embodiments, a tear boundary will be applied to restrict the predetermined tear path short of the peripherally outermost attachment portions of the lid. In other embodiments, the lid has curves, bends, or boundaries that restrict the tear instead of adding an additional boundary.

Although only a few embodiments are disclosed in detail, it should be understood that numerous other embodiments are possible based on the wide variety of lids existing in the marketplace. The configuration of and formation process for the lines of weakness will vary based on the particular lid design for which the added functionality is intended. This invention can be applied on various lids.

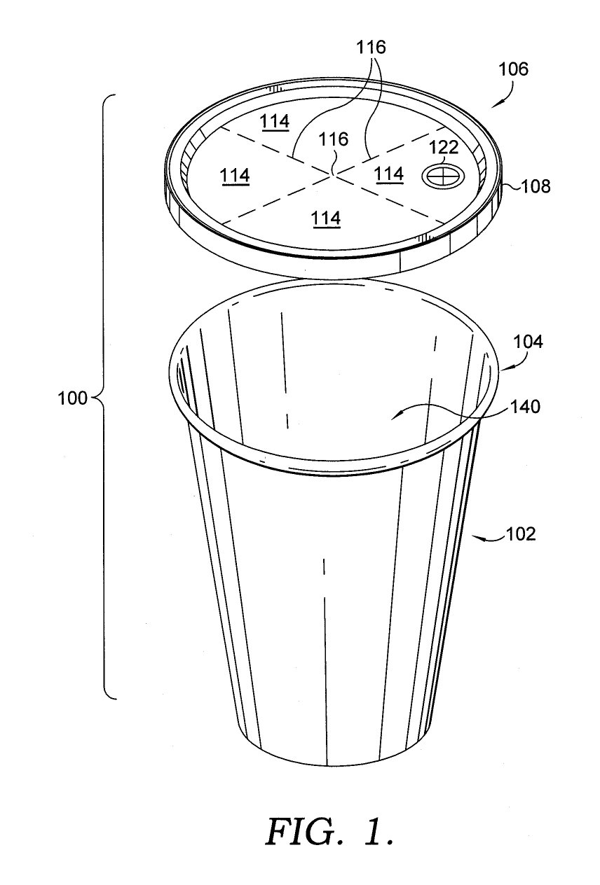

A first embodiment is shown in FIGS. 1-3. This lid might be used as a lid for a standard drink cup. For example, this embodiment might be most useful on a cup used to contain fountain drinks or other consumable liquids.

Looking first at the perspective view of FIG. 1, the system 100 is comprised of a standard cup 102 used to hold liquid (e.g., a fountain drink) in a holding chamber 140, and a lid 106. The lid 106 of the present invention contains predetermined lines of weakness 116 which will later be ruptured. As already discussed, the lines of weakness 116 can be created by scoring, perforation, injection molding, stamping, chemical treatment, laser ablation, ultrasonic administrations, die casting, or other methods. In the embodiments shown in figures, the lines of weakness 116 are formed by perforation and/or scoring, but other techniques noted above could also be used.

The lid 106 is equipped with an outer peripheral attachment portion 108 which is pressed onto an outwardly extending lip 104 of the cup 102 to secure the lid 106. A containment portion 114 of the lid includes everything inside of the attachment portion 108, and serves as a liquid barrier, in some embodiments, substantially enclosing said cup 102. A straw aperture 122 is located in the enclosed containment portion 114 of the lid 106 so that a straw may be inserted for drinking.

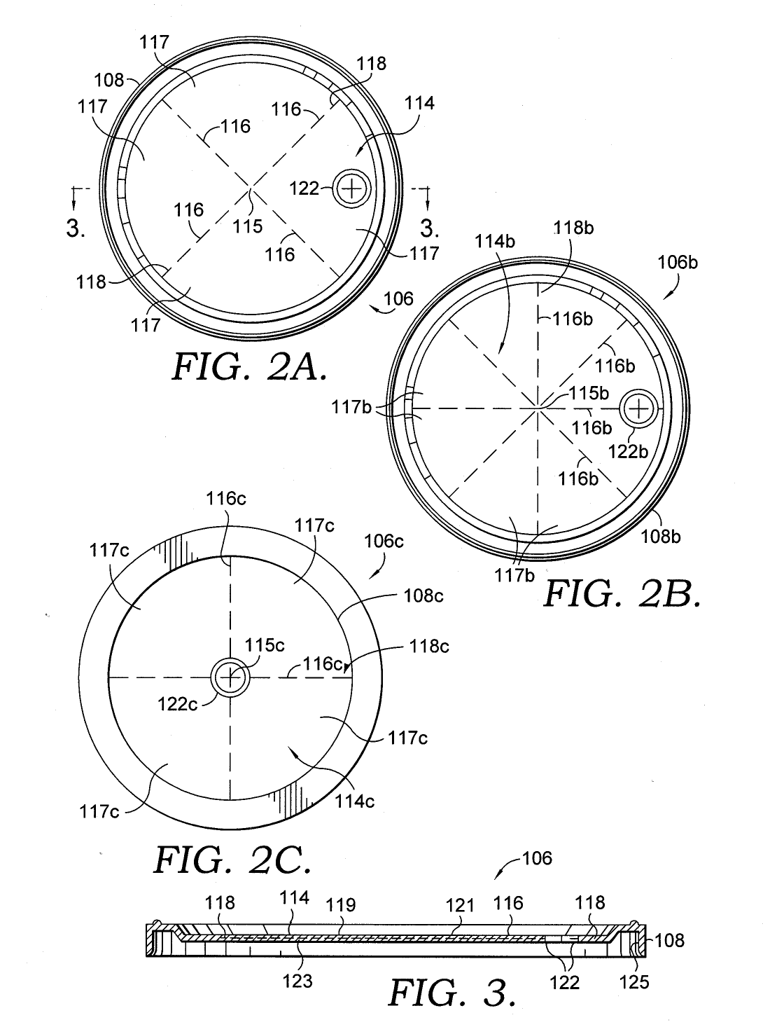

Referring now to FIG. 2A, lid 106 is shown from above. Lines of weakness 116 are shown radiating from a center point 115 of the lid 106. This creates four somewhat elastically hinged flaps 117 which can be ruptured inward. Thus, enclosed portion of the lid body 114 can be penetrated to allow for the receipt of trash or other solid objects. Although not shown precisely in the figures, an outermost extent 118 of each line 116 terminates slightly before reaching the peripheral attachment portion 108 of the lid 106. This is so done so that the integrity of the rim-securing peripheral attachment portion 108 of the lid 106 is not compromised.

Looking now to FIG. 3, the lid 106 shown in FIG. 2A can be seen in cross section, and for illustration, a score line represents the line of weakness 116 as opposed to the perforations in FIG. 2A. The line of weakness 116 radiates from the center point 115, and as visible in FIG. 3, the containment portion 114 has a thinned out structure, which is created by removing material to a depth 119, such that a weakened portion 123 is left to contain the fluid; the weakened portion 123, thus, can effectively retain a fluid, but can rupture with less effort, as compared to a lid 106 with consistently full thickness. The termination points 118 of the lines of weakness 116 can also be seen in this view, as being short of the lip 108.

As is well known, after a desired consumable fluid is received in cup 102, the user will push down onto the lid 106 so that the lip 104 of the cup 102 is received and snapped into a receiving portion 125 (see FIG. 3), which causes the lid 106 to be held into place and then a straw (not shown) is inserted through the hole 122.

After the liquid has been consumed, the user may discard the straw. Or with a conventional cup/lid arrangement, discard the whole item including the cup 102, lid 106, and straw.

The system 100 disclosed herein, however, has further usefulness as a trash (or other sort of) receptacle. In order to use the system 100, the straw (not shown) can be removed from the cup lid 106 and discarded, or simply pushed into the cup chamber 140. Then the cup 102 can be either maintained in the car or other useful place as a trash receptacle or utilized immediately.

Upon the existence of an item for discard, the user can cause the lines of weakness 116 to rupture. This rupturing can be accomplished as a preliminary measure by pushing against the lid 106 with a finger, or can be done concurrently with the forcing of a discardable item through the cup lid 106 into the cup 102. Regardless, the tear lines 116, when ruptured, create flaps 117 (FIG. 2A) which will bend inward to allow passage of the article into the cup chamber 140 where it will remain. Unless the cup chamber 140 is mostly full, the flaps 117, which are resilient, will return back to place so that the article of trash will not come out.

This process is true for each successive item of trash until the cup chamber 140 is almost full. When the trash reaches the top of the cup chamber 140, and the trash inside has been compacted to a sufficient level, points created at the end of each of the flaps 117 will engage into the trash just introduced, and not return resiliently back. Once this is observed by a user, that user will know that the cup chamber 140 is nearly full, and that the entire unit 100 can be emptied or discarded.

These processes are substantially the same for the alternative embodiment shown in FIG. 2B. The FIG. 2B lid embodiment 106b (as seen from above) has a total of four lines of weakness 116b used to create eight hinged flaps 117b when ruptured. In this embodiment, the lines of weakness 116b radiate from the center 115b of the lid 106b, enabling an enclosed containment portion 114b of the lid 106b to be penetrated to allow for the receipt of trash or other non-liquid objects. Like with the last embodiment, termination points 118b of each line of weakness 116b terminate before reaching a radial outermost attachment portion 108b of the lid 106b to protect the integrity of the securing outer portion 108b. In this embodiment, one line of weakness is aligned with a straw aperture 122b.

FIG. 2C shows an embodiment where lines of weakness 116c are used to cause a lid 106c to rupture into four elastically hinged flaps 117c. In this embodiment, the lines of weakness 116c radiate from near the center 115c of the lid 106c enabling an enclosed portion 114c of the lid 106c to be penetrated to allow for the receipt of trash or other non-liquid objects. Again here, an outermost extent of each line of weakness 118c terminates before reaching a radial outermost attachment portion 108c of the lid 106c. Unlike the past embodiments, however, a straw hole 122c is located near the intersection of the lines of weakness 116c, involving the straw hole 122c as the rupture center. Otherwise, the processes for using lid 106c are much that same as for the lids 106a and 106b previously mentioned.

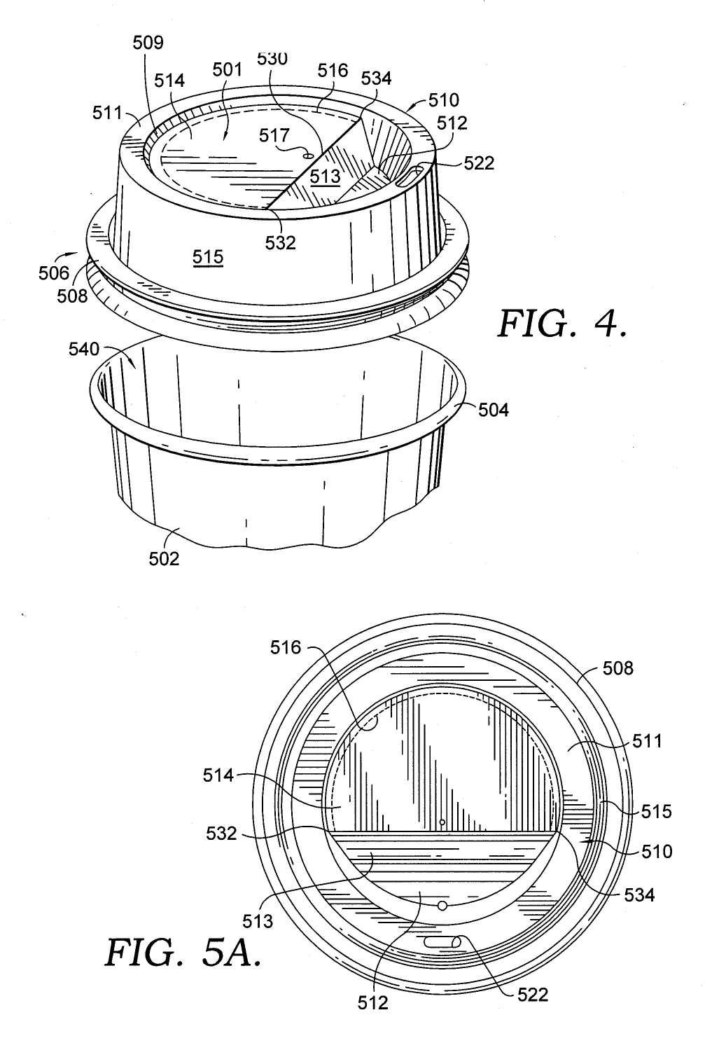

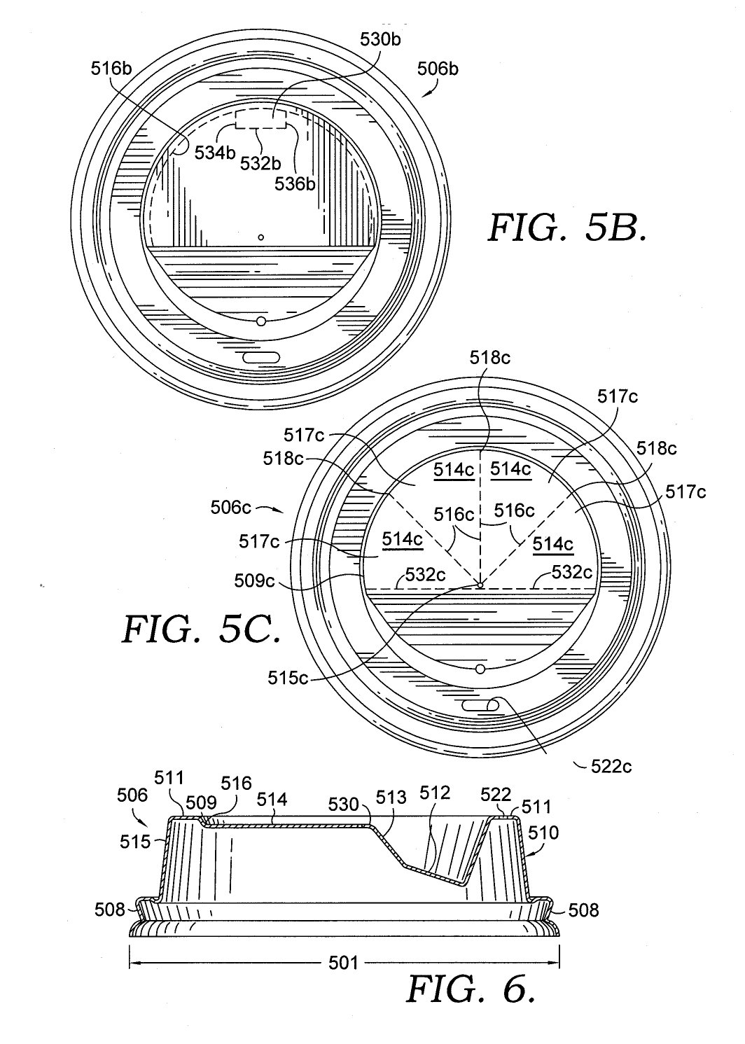

Embodiments for a different kind of cup (e.g., a coffee cup) are shown in FIGS. 4-6. FIG. 4 shows the arrangement in perspective with a cup 502, FIGS. 5A-C show embodiments from above, and FIG. 6 shows a sectional view taken across the middle of the embodiment shown in FIG. 5A. The system shown in FIGS. 4, FIG. 5A, and 6 comprises the standard hot liquid cup 502 equipped with an outwardly extending lip 504 and a lid 506. Lid 506 is designed with an outer peripheral attachment portion 508 which receives the outwardly extending lip 504 of the cup 506. A containment portion 501 includes a variety of subparts, e.g., parts 515, 511, 509, 514, 513, 512, 510. A raised structural portion 510 has an upwardly sloped surface 515 which extends upwardly to a flat top 511. Flat top 511 dips down slightly at an inward position to morph into a penetrable plateau portion 514 via a slight riser 509.

With respect to lid 506, the penetrable plateau portion 514 terminates just past an airhole 517 into a downwardly sloping portion 513 which leads to a lower trough 512 formed in the lid 506. A sipping aperture 522 is located at on the top flat surface 511 of the raised structural portion 510.

The embodiment shown in FIGS. 4, 5A, 6 have a C-shaped line of weakness 516 which follows the curved contour of the lid 506 and extend between two end points 532 and 534 on a front ridge 530. The front ridge 530 exists at the transition from the plateau portion 514 to the sloping portion 513. This arrangement will enable penetration and the inward folding of plateau portion 514, causing the front ridge 530 to serve as a fold line (or a sort of hinge) during the insertion of trash or other articles into a cup chamber 540, when the lid 506 of this embodiment is utilized.

In use, the lid 506 works using much of the same processes as disclosed above, except that the lines of weakness 516 will cause one single flap to be formed into the plateau portion 514 of the lid 506, as can be understood. More specifically, a user can use a finger or an item (e.g. of trash) to push against the plateau portion 514 causing the lid 506 to tear along the lines of weakness 516. Once insertion of an item of trash is begun, plateau portion 514 becomes a hinged flap having edges defined by the line of weakness 516. The now torn section 514 will bend inward until the article has passed into the chamber 540 inside cup 502. Then the elastically hinged flap will (to an extent) retract back to retain the trash and close (to an extent) the opening created in the lid 506. This same process will continue for successive articles of trash until the cup chamber 540 is full as indicated by the flap edges catching on the last article inserted and not elastically returning.

The alternative embodiment 506b disclosed in FIG. 5B is almost the same as the FIG. 5A embodiment except that it has a knock out portion 530b defined by deep score boundaries 532b, 534b, and 536b. These deep score boundaries are made to be slightly more frangible (e.g., by means of increased score depth) than C-shaped lines of weakness 516b used to create the flap which will be used for retention means when the item is used as a receptacle. The knock out portion 530b, when removed, creates an aperture that reduces the pinching aspect of the sturdy lid flaps.

Another alternative score line configuration is shown in FIG. 5C. Referring to this figure, it can be seen that lines of weakness 516c, and a forward line of weakness 532c extend linearly outward from a common origin 515c which is slightly offset from a center of lid 506c.

This arrangement will create a large trash opening in the lid 506c, when in use. An outermost extent 518c of each line of weakness 516c terminates at the end of a plateau portion 514c of this embodiment (it is helpful to refer to the cross section shown in FIG. 6 to see this since the subject lids are the same) where it transitions to a riser 509c. When an article of trash is inserted into the cup using this lid 506c, the item will be pressed against the plateau portion 514c which, because of the lines of weakness 516c and 532c, will result in the creation of four inwardly bending hinged flaps 517c. The sharp ends formed at the end of each flap 517c will bite into the last entered item of trash in a full cup as described in the processes associated with the FIG. 1-3 embodiments.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and sub-combinations are of utility and may be employed without reference to other features and sub-combinations and are contemplated within the scope of the claims. Not all steps listed in the various figures need be carried out in the specific order described.

The invention claimed is:

1. A lid for a cup defining a liquid receiving area, said cup having an upper rim and a mouth, said lid comprising:
an outer peripheral portion of the lid, said outer peripheral portion including means to receive said upper rim of said cup and be secured onto said cup;
an liquid barrier portion of said lid, said barrier portion preventing said liquid from splashing out of said cup when said lid is secured;
a first line of weakness defined in the lid, said first line of weakness enabling at least a portion of said barrier portion to be ruptured to enable the passage of an object having a dimension which is greater than the radius of the mouth of the cup, the first line of weakness being one of linear and curved.

2. The lid of claim 1 comprising:
a second line of weakness;
said first and second lines of weakness crossing at or near a middle of the lid and when ruptured, said first and second lines creating four flaps, the flaps being inwardly flexible to allow for the passage of an object into the cup.

3. The lid of claim 2 wherein the flaps, after the passage of the object, aid in retaining the object in the cup.

4. The lid of claim 1 comprising:
a second line of weakness, a third line of weakness, and a fourth line of weakness;
said first, second, third, and fourth lines of weakness crossing at or near a middle of the lid and when ruptured, said first, second, third, and fourth lines of weakness defining eight flaps, the flaps being inwardly flexible to allow for the passage of an object into the cup, and then retaining the object in the cup after passage therethrough.

5. The lid of claim 1 wherein the first line of weakness is curved.

6. The lid of claim 5 wherein the first line of weakness is C-shaped.

7. The lid of claim 6 wherein the C-shaped first line of weakness is defined about a plateau portion of the lid.

8. The lid of claim 7 wherein a knockout portion is defined at a location along the first line of weakness.

9. The lid of claim 1 wherein the first line of weakness is included in a plurality of lines of weakness, all of the lines in the plurality existing in a plateau portion of the lid and emanating from a common point to define a plurality of flaps.

10. The lid of claim 1 wherein the first line of weakness is one of: a scored line, a perforated line, and deposited chemical.

11. A substantially circular lid for a cup comprising:
an outer portion adapted to snap on to a conventional cup;
an inner portion including at least one rupturable line defined in said lid;
said at least one line, when ruptured, defining a hinged flap, said flap enabling said lid to be substantially opened up for the passage of solid items through said lid for containment.

12. The lid of claim 11 wherein said lid is adapted to allow the passage of an object having a diameter as large as the radius of a mouth of the cup.

13. A method for enabling the use of a cup as a trash receptacle, the method comprising:
weakening an area on a lid on the cup so that the lid can be ruptured to form at least one flap through which objects can be inserted and held securely.

14. The method of claim 13 comprising:
weakening the area by creating at least one line of weakness to define the at least one flap.

15. The method of claim 14 comprising:
forming the at least one line of weakness into a C-shape to create said at least one flap.

16. The method of claim 14 comprising:
forming the at least one line of weakness by one of scoring, perforating, chemically treating, injection molding, stamping, laser ablating, ultrasonic administrations, and die casting.

17. The method of claim 13 comprising:
weakening the area by creating two intersecting lines of weakness to form four flaps.

18. The method of claim 13 comprising:
weakening the area by creating lines of weakness to form more than four flaps.

19. The method of claim 13 comprising:
providing a cup lid that has a rim portion adapted to be secured on an upper mouth of a cup, the cup lid having a substantially flat containment portion; and,
selecting the containment portion on the lid to serve as the area for weakening.

20. The method of claim 13 comprising:
providing a cup lid that has an outer peripheral attachment portion which is adapted to receive and be secured onto an outwardly extending lip around a cup, the cup lid also having a flat top that dips down to form into a plateau portion; and,
selecting the plateau portion on the lid to serve as the area for weakening.
